(19) United States
(12) Patent Application Publication
(10) Pub. No.: US 2022/0290418 A1
(43) Pub. Date: Sep. 15, 2022

(54) MOBILE WASHING STATION

(71) Applicant: Rachel Dombrowsky, Hewlett, NY (US)

(72) Inventors: Rachel Dombrowsky, Hewlett, NY (US); Richard J. Kocinski, Punta Gorda, FL (US); Joseph Toro, E. Patchogue, NY (US); John Leavitt, Rockville Centre, NY (US)

(21) Appl. No.: 17/690,143

(22) Filed: Mar. 9, 2022

Related U.S. Application Data
(60) Provisional application No. 63/158,567, filed on Mar. 9, 2021.

(51) Int. Cl. E03C 1/182; E03C 1/32; B62B 3/02; C02F 1/32; C02F 1/00

(52) U.S. Cl. CPC E03C 1/182; E03C 1/32; B62B 3/02; C02F 1/325; C02F 1/001; E03C 2201/40; C02F 2201/3222; C02F 2201/3227; C02F 2303/04; C02F 2307/06; C02F 2201/008

(57) ABSTRACT

A mobile washing station includes a base portion and a column that extends vertically from the base portion. An upper portion is supported on the adjustable column and includes a basin, a drain, and a faucet. A clean water tank is in fluid communication with the faucet via a water line. A water pump is designed to pump water from the clean water tank through the water line to the faucet. A wastewater tank is in fluid communication with the drain via a drainage line.

### CROSS-REFERENCE TO RELATED APPLICATION

This application claims the benefit of and priority to U.S. Provisional Patent Application No. 63/158,567, filed on Mar. 9, 2021, the entire contents of which being incorporated by reference herein.

The present disclosure relates to mobile washing stations for use independent of traditional plumbing infrastructure. More specifically, the present disclosure relates to mobile washing stations that can be repositioned to service immobile users who are unable to stand or get out of bed.

### BACKGROUND

Traditional washing stations are tethered to permanent plumbing infrastructure and require a user to have a minimal amount of mobility to make proper use of them. As such, traditional washing stations cannot be properly used or enjoyed by persons who do not have the requisite amount of mobility, for example, patients recovering from surgery or the permanently disabled. Further, traditional washing stations are normally fixed to a specific location in a room or building, and therefore cannot provide service to persons in need of washing stations while not located in such rooms/buildings equipped with plumbing infrastructure. For example, a doctor providing patient care at an off-site field clinic, or a cook prepping food for an outdoor event.

The limitations of traditional washing stations are well-known and commonly accepted as unavoidable but necessary. A common work-around for such limitations is to simply bring a bowl or large container of water and attempt to wash yourself with the water available. Of course, using a simple bowl in this manner sacrifices the convenience provided by plumbing infrastructure. For example, a simple container does not provide a faucet to control the outflow stream of clean water, or a drainage system to receive the runoff. Using a simple container forces the user to either make a mess pouring out a portion of the water or to taint the entire water supply by washing within the container.

The mobile washing stations disclosed herein provide all the convenience of traditional washing stations for users unable to access traditional washing stations.

### SUMMARY

According to an aspect of the present disclosure, a mobile washing station is provided that includes a base portion, a column extending vertically from the base portion, and an upper portion supported on the column. The upper portion includes a basin, a drain, and a faucet. The mobile washing station further includes a clean water tank in fluid communication with the faucet via a water line, a water pump configured to pump water from the clean water tank through the water line to the faucet, and a wastewater tank in fluid communication with the drain via a drainage line.

In aspects, the mobile washing station may include a controller including a power supply. The controller is operably coupled to the water pump.

In aspects, the base portion may include a proximal end, a distal end, and an elongate portion connecting the proximal and distal ends, such that the proximal end, the distal end, and the elongate portion together define a C-shaped cavity configured to receive a vertical support of a bed.

In aspects, the base portion may have a plurality of wheels to allow for rolling the base portion along a floor.

In aspects, the base portion, the column, and the upper portion may collectively define a C-shaped cavity configured to receive a horizontal size of a bed such that the upper portion is positionable over the bed and the base portion is positionable underneath the bed.

In aspects, the mobile washing station may further include a removeable platform configured to rest on the base portion and to receive the clean water tank and the wastewater tank. The removeable platform may include a floor and at least one sidewall.

In aspects, the floor of the removeable platform may include a floor port in fluid communication with the water line. The floor port may define a protrusion configured to be inserted into the clean water tank.

In aspects, the at least one sidewall of the removeable platform may include a wall port in fluid communication with the drainage line. The wall port may define a protrusion configured to be inserted into the wastewater tank.

In aspects, the mobile washing station may further include a UV lamp positioned adjacent to at least one of the clean water tank or the wastewater tank. The UV lamp may be configured to sanitize fluid stored within at least one of the clean water tank or the wastewater tank.

In aspects, the mobile washing station may further include a plurality of UV LEDs disposed along an interior surface of the water line. The UV LEDs may be configured to sanitize fluid flowing through the water line.

In aspects, the faucet may be hingedly coupled to the upper portion and configured to fold downward into the basin.

In aspects, the mobile washing station may further include a removable countertop configured to be selectively attached to the upper portion. The countertop may define a horizontal plane above the upper portion.

In aspects, the mobile washing station may further include a removable solid waste filter operably coupled to the drain. The filter may be configured to remove solid particulates from fluid flowing down the drain before entering the drainage line.

In aspects, the faucet may be operably coupled to a motion sensor, which when triggered, is configured to cause the faucet to activate without physical contact with the faucet.

In accordance with further aspects of the present disclosure, a mobile washing station is provided that includes a housing, an articulating arm rotationally supported on the housing, a basin supported on an end of the articulating arm, a clean water tank, a water pump, and a wastewater tank. The articulating arm is configured to move relative to the housing between a retracted position and an extended position. The basin includes a faucet and a drain and the clean water tank is in fluid communication with the faucet via a water line. The water pump is configured to pump water from the clean water tank upward through the water line to the faucet. The wastewater tank is in fluid communication with the basin via a drainage line.

In aspects, the water line and the drainage line may extend through an interior channel defined through the articulating arm to the faucet and the drain, respectively.

In aspects, the housing may be supported on a plurality of wheels.

In aspects, the mobile washing station may further include a UV lamp supported within the clean water tank. The UV lamp may be configured to sanitize fluid stored within the clean water tank.

In aspects, the mobile washing station may further include a plurality of UV LEDs disposed along an interior surface of the water line. The UV LEDs may be configured to sanitize fluid flowing through the water line.

In aspects, the articulating arm may include a first arm rotationally supported on the housing, and a second arm rotationally coupled to the first arm and supporting the basin. When the articulating arm is in the retracted position the basin may be overlapping the housing, and when the articulating arm is in the extended position the basin may be positioned away from the housing.

Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIG. 1 is a perspective view of a mobile washing station in accordance with the principles of the present disclosure;

FIG. 2 is a perspective view of a mobile washing station with a removable countertop in use with a bed in accordance with the principles of the present disclosure;

FIG. 3 is a front view of the mobile washing station of FIG. 1;

FIG. 4 is a back view of the mobile washing station of FIG. 1;

FIG. 5 is a block diagram illustrating the controller operations of the mobile washing station of FIG. 1;

FIG. 6A is a sideview of the mobile washing station of FIG. 1 in a retracted position;

FIG. 6B is a sideview of the mobile washing station of FIG. 1 in an extended position;

FIG. 7A is a close-up view of the upper portion of the mobile washing station of FIG. 1 in an open position;

FIG. 7B is a close-up view of the upper portion of the mobile washing station of FIG. 1 in a closed position in use with a removable countertop of FIG. 1;

FIG. 8A is a perspective view of a removable platform being equipped with a clean water tank of the mobile washing station of FIG. 1;

FIG. 8B is a perspective view of a removable platform being equipped with a wastewater tank of the mobile washing station of FIG. 1;

FIG. 9 is a perspective view of an extendable washing station in a retracted position in accordance with the principles of the present disclosure;

FIG. 10 is a perspective view of the extendable washing station of FIG. 9 in an extended position;

FIG. 11 is a perspective view of a removable solid waste filter for use with a drain of the mobile washing station of FIG. 1 or the extendable washing station of FIG. 9; and

FIG. 12 is a perspective view of a water line including a plurality of UV LEDs disposed therein for use with a faucet of the mobile washing station of FIG. 1 or the extendable washing station of FIG. 9.

Further details and aspects of the disclosure are described in more detail below with reference to the appended figures. Any of the above aspects of the disclosure may be combined without departing from the scope of the present disclosure.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

The present disclosure provides mobile washing stations that offer the convenience of running water and proper drainage independent from permanent plumbing fixtures. The mobile washing stations are useful in a variety of settings including, but not limited to, hospitals, homes, laboratories, etc. The mobile washing stations are vertically and/or laterally adjustable to accommodate bed-ridden patients who are unable to get up and use a conventional washing station.

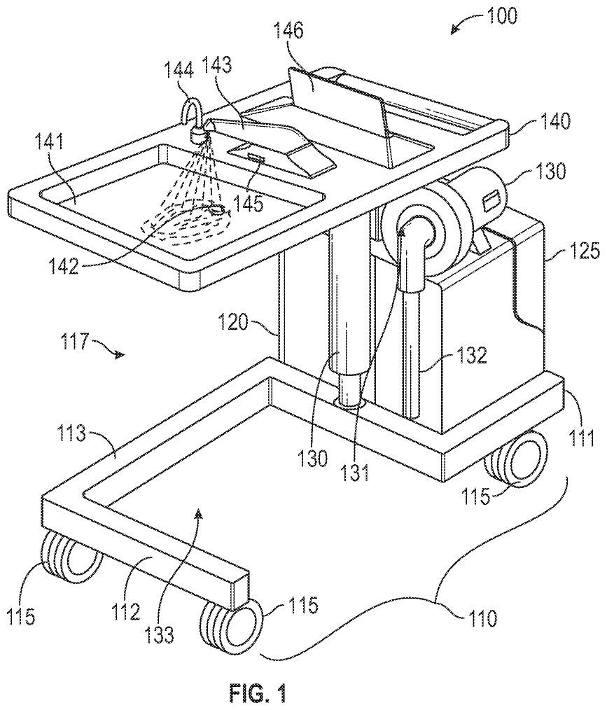

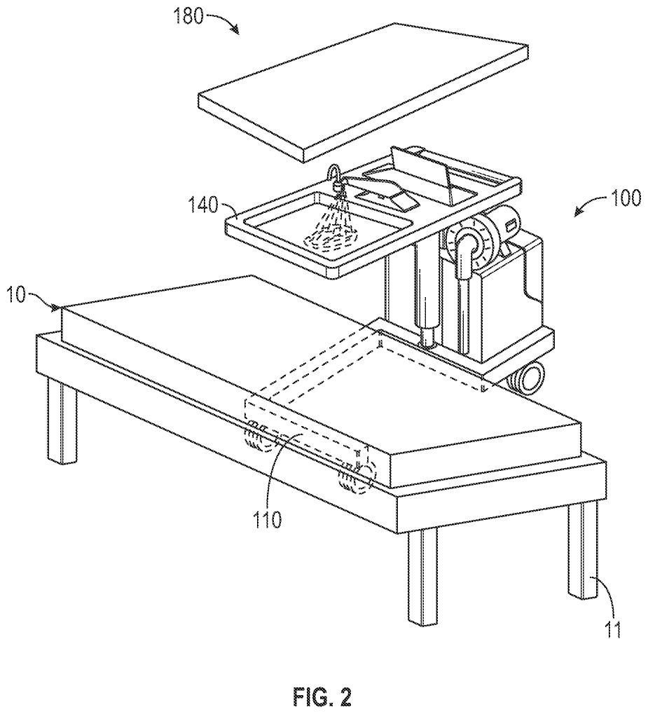

With reference to FIGS. 1-3, a mobile washing station, such as a mobile washing station 100 is illustrated and generally includes a base portion 110, an adjustable column 130, and an upper portion 140. The base portion 110 is mounted atop a plurality of caster wheels 115 that allow the base portion 110 to slide under a bed 10 while the upper portion 140 is brought into position over the bed 10. The adjustable column 130 is mounted atop a broad proximal end 111 of the base portion 110, and also supports the upper portion 140. As such, the base portion 110 and the upper portion 140 are interconnected to one another by the adjustable column 130.

The base portion 110 includes the broad proximal end 111 connected to a narrow distal end 112 by an elongate portion 113, such that when viewed from above the broad proximal end 111, the narrow distal end 112, and the elongate portion 113 define a partially enclosed C-shaped cavity 133. The partially enclosed C-shaped cavity 133 allows the base portion 110 to slide around at least one vertical support 11 of the bed 10 when the base portion 110 is being rolled into position under the bed 10. The base portion 110, the column 130, and the upper portion 140 collectively define a C-shaped cavity 117 configured to receive a horizontal side of the bed 10 when the base portion 110 is slid underneath the bed 10.

The mobile washing station 100 is structured to allow patients, e.g., those who are unable to get out of bed, access to a washing station without having to move from the bed 10. The upper portion 140 includes a faucet 143 that provides a controlled stream of clean water for the patient, as well as a soap dispenser 144, a paper dispenser 146 (e.g., tissue paper or paper towel), and a basin 141 for the patient to use while washing. The faucet 143 receives clean water from a clean water tank 125 that is supported on the broad proximal end 111 of the base portion 110. A water pump 131 pumps the clean water up to the faucet 143 via a water line 132.

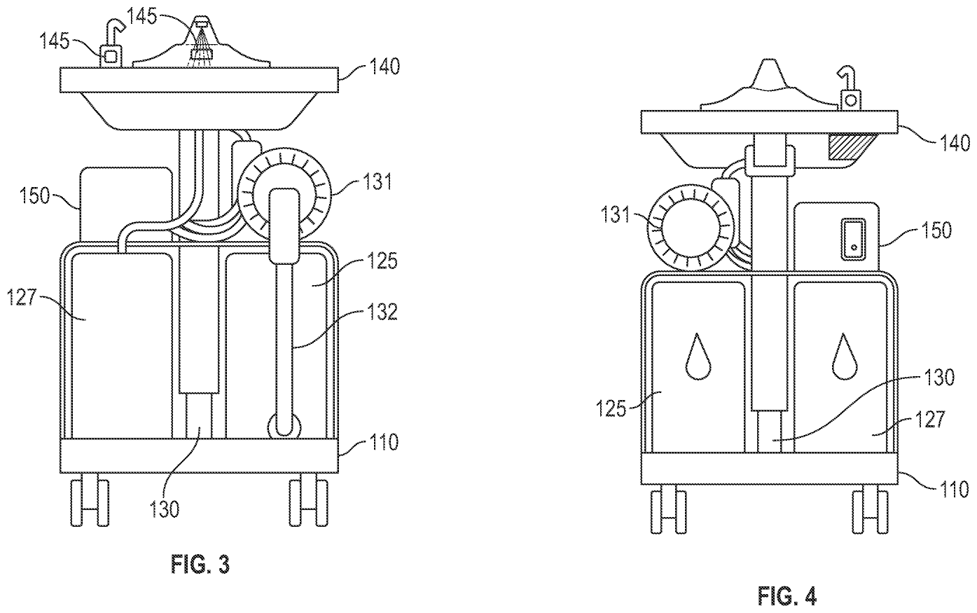

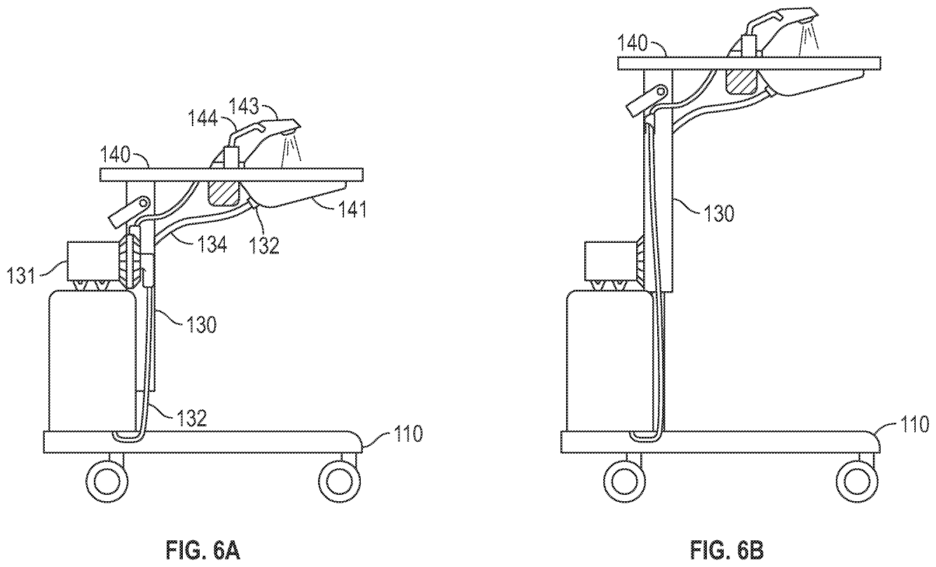

In use, the wastewater or runoff flows down through a drain 142 positioned at the low point of the basin 141. The wastewater flows through a drainage line 134 (FIG. 6A) to a wastewater tank 127 (FIGS. 3-4) where it is temporarily stored for later disposal. The upper portion 140 also includes at least one motion sensor 145 that coupled to the faucet 143 and the soap dispenser 144. The motion sensor 145 is triggered by simple actions, such as a waving hand, and when triggered causes the faucet 143 or the soap dispenser 144 to activate without physical contact. In aspects, each of the faucet 143 and the soap dispenser 144 are activated by separate motion sensors that can be independently triggered. In other aspects, the faucet 143 and soap dispenser 144 may be manually actuated via a lever or button.

FIGS. 3 and 4 illustrate the mobile washing station 100 from a frontal view and rear view, respectively. Both views show where the clean water tank 125 and the wastewater tank 127 are supported on the base portion 110 alongside the adjustable column 130. The adjustable column 130 is positioned centrally between the clean water tank 125 and the wastewater tank 127 to provide separation between the tanks 125, 127 and to increase the overall structural stability of the mobile washing station 100. The water pump 131 rests atop the clean water tank 125, and a controller 150 rests atop the wastewater tank 127 to minimize the surface area of the broad proximal end 111 of the base portion 110. In aspects, the water pump 131 and the controller 150 may also be positioned on the broad proximal end 111 alongside the clean water tank 125 and wastewater tank 127, and the adjustable column 130 may also be positioned non-centrally without separating the clean water tank 125 and wastewater tank 127.

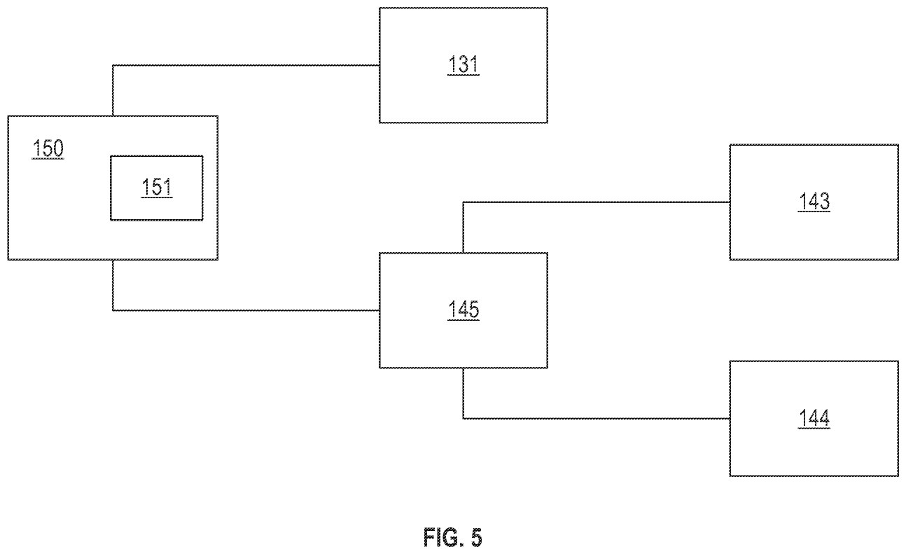

With reference to FIG. 5, the controller 150 includes a power supply 151 and is in direct communication with the motion sensor 145. As discussed above, the motion sensor 145 is operably coupled to the faucet 143 and to the soap dispenser 144. In aspects, the controller 150 may also be in direct communication with the faucet 143 and to the soap dispenser 144, allowing the end user to activate the faucet 143 and the soap dispenser 144 independent from the motion sensor 145.

FIGS. 6A and 6B both illustrate the mobile washing station 100 from a sideview. FIG. 6A shows the mobile washing station 100 in a retracted position. When retracted, the adjustable column 130 is set to its minimum height such that the upper portion 140 is as low as possible over the bed. To accommodate beds of varying height, the adjustable column 130 can be raised to a higher position as shown in FIG. 6B. In aspects, the adjustable column 130 may include an actuation motor operably coupled to the controller 150 so that adjustment of the height of adjustable column 130 can be automated.

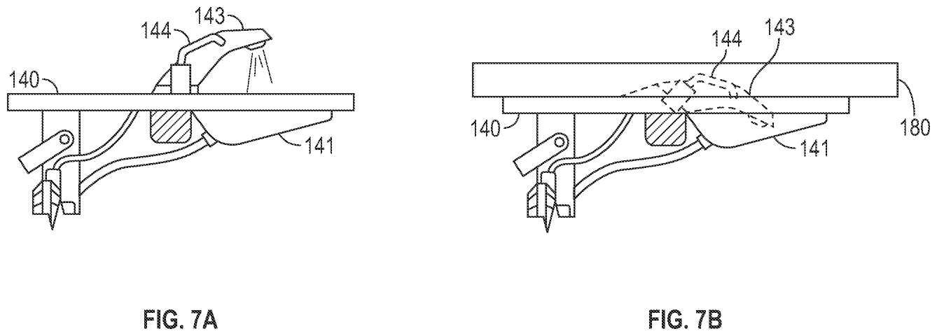

FIGS. 7A and 7B both illustrate the upper portion 140 of the mobile washing station 100 from a sideview. FIG. 7A shows the upper portion 140 in the normal operating or open position. In the open position, the faucet 143 and the soap dispenser 144 stand upright and ready for use. In the closed position, as shown in FIG. 7B, the faucet 143 and the soap dispenser 144 are both rotated about a hinged connection to the upper portion 140. The basin 141 is sized and proportioned to receive the faucet 143 and the soap dispenser 144 when rotated into the closed position. When rotated into the closed position, a removable countertop 180 can be placed on top of the upper portion 140 to provide an expanded open surface area. In aspects, the removable countertop 180 may also include one or more fasteners that can firmly hold the removable countertop 180 in place over the upper portion 140 when attached.

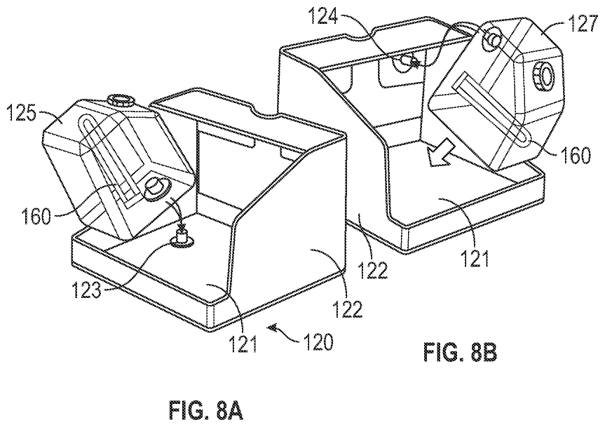

FIGS. 8A and 8B both illustrate a removable platform 120 that can be installed onto the base portion 110. The removable platform 120 includes at least one sidewall 122 and a floor 121. The floor is sized to rest atop the broad proximal end 111 of the base portion 110, and to receive the clean water tank 121 and the wastewater tank 127. The removable platform 120 is prefabricated to include a floor port 123 that facilitates a seamless connection between the clean water tank 125 and the clean water line 132. The floor port 123 is a vertical protrusion that is configured to be inserted into matching receiving port positioned on the lower end of the clean water tank 125. Similarly, the removable platform 120 is also prefabricated to include a wall port 124 that facilitates a seamless connection between the wastewater tank 127 and the drainage line 134. The wall port 124 is a horizontal protrusion that is configured to be inserted into matching receiving port positioned on the distal end of the wastewater tank 127.

The clean water tank 125 and the wastewater tank 127 may each include a UV lamp 160 supported on an interior surface of the tanks 125, 127. The UV lamp 160 emits ultraviolet light that can be used to sanitize the fluid stored within the tanks 125, 127. In other aspects, the removable platform 120 may also include an indentation to accommodate the adjustable column 130 between the clean water tank 125 and the wastewater tank 127.

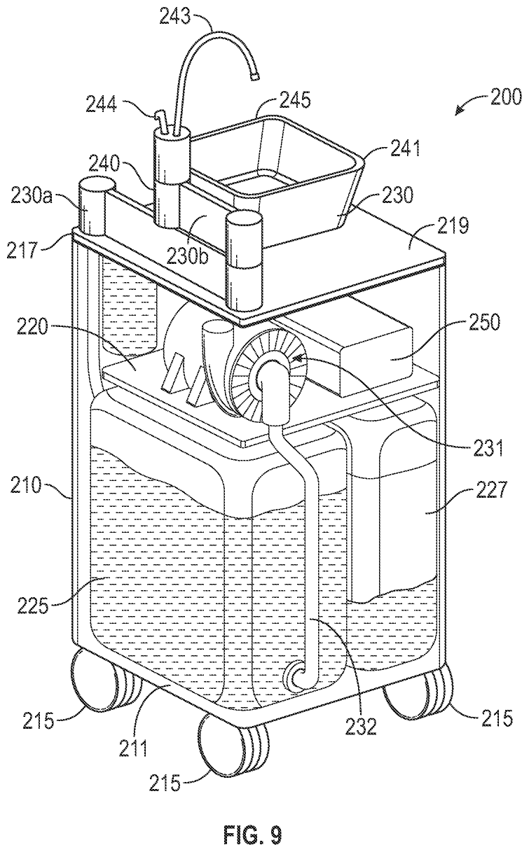

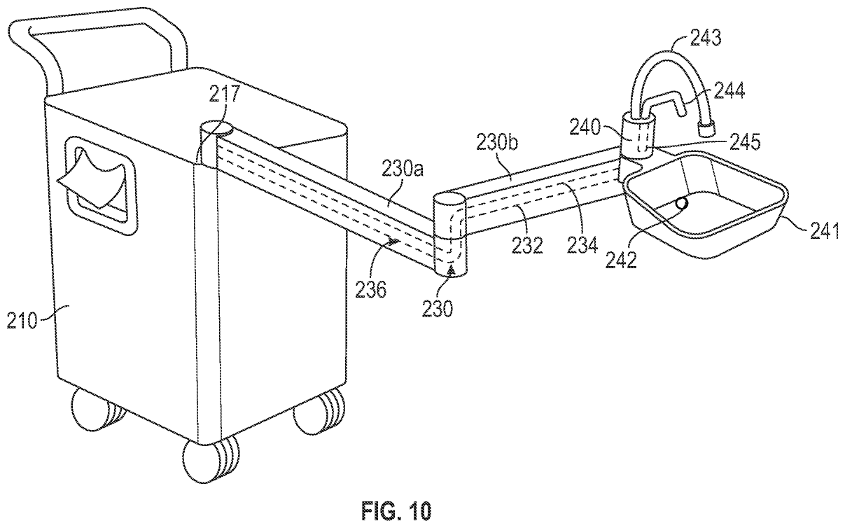

With reference to FIGS. 9 and 10, a mobile washing station, such as an extendable washing station 200 is illustrated. The mobile washing station 200 is similar to and may include any of the features of the mobile washing station 100 of FIG. 1 except as explicitly contradicted below.

The mobile washing station 200 generally includes a housing 210 and an articulating arm 230 supported on the housing 210. The housing 210 is mounted atop a plurality of caster wheels 215 that allow the extendable washing station 200 to be rolled in any direction along the floor. The housing 210 includes a base portion 211, an upper portion 219, and a platform 220 positioned part way between the base portion 211 and the upper portion 219.

Like the mobile washing station 100 discussed above, a faucet 243 of the mobile washing station 200 provides a controlled stream of clean water for the patient, as well as a soap dispenser 244 and a basin 241 for the patient to use while washing. The faucet 243 receives clean water from a clean water tank 225 that is supported on the base portion 211 of the housing 210. A water pump 231 pumps the clean water up to the faucet 243 via a water line 232. The articulating arm 230 includes a first arm 230a rotationally supported on the upper portion 219 of the housing 210, and a second arm 230b rotationally coupled to and interconnecting the first arm 310 and the basin 241.

In use, the wastewater or runoff flows down through a drain 242 positioned at the low point of the basin 241. The wastewater flows through a drainage line 234 to a wastewater tank 227 that is also supported on the base portion 211, where it is temporarily stored for later disposal. A motion sensor 245 is operably coupled to the faucet 243 and the soap dispenser 244. The motion sensor 245 is triggered by simple actions, such as a waving hand, and when triggered causes the faucet 243 or the soap dispenser 244 to activate without physical contact. In aspects, each of the faucet 243 and the soap dispenser 244 are activated by separate motion sensors that can be independently triggered.

FIG. 9 shows where the platform 220 of the housing 210 is positioned high enough above the base portion 211 to receive the clean water tank 225 and the wastewater tank 227, and is also positioned low enough below the upper portion 219 to receive the water pump 231 and a controller 250. The housing 210 defines at least one corner 217 that is used as a mounting point for the first arm 230a of the articulating arm 230. An end 240 of the second arm 230b of the articulating arm 230 supports the basin 241 that includes the faucet 243, the motion sensor 245, the drain 242 and the soap dispenser 244.

As discussed above, with reference to the controller 150 of the mobile washing station shown in FIG. 5, the controller 250 includes a power supply and is in direct communication with the motion sensor 245. The motion sensor 245 is operably coupled to the faucet 243 and the soap dispenser 244. In aspects, the controller 250 may also be in direct communication with the faucet 243 and to the soap dispenser 244, allowing the end user to activate the faucet 243 and the soap dispenser 244 independent from the motion sensor 245.

FIG. 9 shows the articulating arm 230 of the extendable washing station 200 in a retracted position, where the articulating arm 230 is folded in on itself to position the basin 241 to occupy the airspace directly above the upper portion 219 of the housing 210. FIG. 10 shows the articulating arm 230 of the extendable washing station 200 in an extended position, where the articulating arm 230 is outstretched to position the basin 241 to occupy airspace some distance away from the housing 210.

The extendable washing station 200 is structured to allow patients who are unable to get out of bed access to a washing station without having to move from the bed. In use, the extendable washing station 200 is rolled into a position near to the patient, for example next to a bed. The articulating arm 230 and the basin 241 supported thereon are repositioned to extend over the bed to be within reach of the patient. To facilitate the transfer of clean water from the clean water tank 225 up to the faucet 243, a portion of the water line 232 is passed through an interior channel 236 defined through the articulating arm 230. Similarly, to facilitate the transfer of wastewater or runoff from the drain 242 down to the wastewater tank 227, a portion of the drainage line 234 is also passed through the same interior channel 236 as the water line 232 or a discrete interior channel of the articulating arm 230. In aspects, the articulating arm 230 further includes an actuation motor (not explicitly shown) operably coupled to the controller 250 so that the extension and retraction of the articulating arm 230 can be automated.

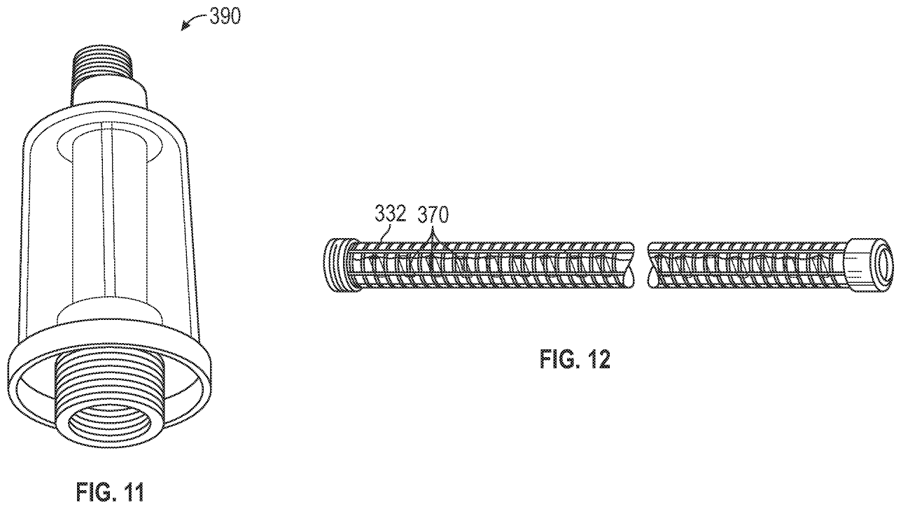

FIGS. 11 and 12 show add-on features that can be used in conjunction with the either the mobile washing station 100 of FIG. 1 or the extendable washing station 200 of FIG. 11. A solid waste filter 390 can be removably coupled to the drain, and configured to remove solid particulates from the fluid flowing down the drain before it enters the drainage line. Further, the water line 332 connecting the faucet to the water tank can include a plurality of UV LEDs 370. The plurality of UV LEDs 370 emit ultraviolet light that can be used to further sanitize the water flowing through the water line 332 before reaching the faucet.

It will be understood that various modifications may be made to the embodiments disclosed herein. Therefore, the above description should not be construed as limiting, but merely as exemplifications of various embodiments. Those skilled in the art will envision other modifications within the scope and spirit of the claims appended thereto.

1. A mobile washing station, comprising:
a base portion;
a column extending vertically from the base portion;
an upper portion supported on the column and including a basin, a drain, and a faucet;
a clean water tank in fluid communication with the faucet via a water line;
a water pump configured to pump water from the clean water tank through the water line to the faucet; and
a wastewater tank in fluid communication with the drain via a drainage line.

2. The mobile washing station of claim 1, further comprising a controller including a power supply, the controller operably coupled to the water pump.

3. The mobile washing station of claim 1, wherein the base portion includes a proximal end, a distal end, and an elongate portion connecting the proximal and distal ends, such that the proximal end, the distal end, and the elongate portion together define a C-shaped cavity configured to receive a vertical support of a bed.

4. The mobile washing station of claim 1, wherein the base portion has a plurality of wheels to allow for rolling the base portion along a floor.

5. The mobile washing station of claim 1, wherein the base portion, the column, and the upper portion collectively define a C-shaped cavity configured to receive a horizontal size of a bed such that the upper portion is positionable over the bed and the base portion is positionable underneath the bed.

6. The mobile washing station of claim 1, further comprising a removeable platform configured to rest on the base portion and to receive the clean water tank and the wastewater tank, the removeable platform including a floor and at least one sidewall.

7. The mobile washing station of claim 6, wherein the floor of the removeable platform includes a floor port in fluid communication with the water line, the floor port defining a protrusion configured to be inserted into the clean water tank.

8. The mobile washing station of claim 6, wherein the at least one sidewall of the removeable platform includes a wall port in fluid communication with the drainage line, the wall port defining a protrusion configured to be inserted into the wastewater tank.

9. The mobile washing station of claim 1, further comprising a UV lamp positioned adjacent to at least one of the clean water tank or the wastewater tank, the UV lamp being configured to sanitize fluid stored within at least one of the clean water tank or the wastewater tank.

10. The mobile washing station of claim 1, further comprising a plurality of UV LEDs disposed along an interior surface of the water line, the plurality of UV LEDs being configured to sanitize fluid flowing through the water line.

11. The mobile washing station of claim 1, wherein the faucet is hingedly coupled to the upper portion and configured to fold downward into the basin.

12. The mobile washing station of claim 11, further comprising a removable countertop configured to be selectively attached to the upper portion, the countertop defining a horizontal plane above the upper portion.

13. The mobile washing station of claim 1, further comprising a removable solid waste filter operably coupled to the drain, the filter being configured to remove solid particulates from fluid flowing down the drain before entering the drainage line.

14. The mobile washing station of claim 1, wherein the faucet is operably coupled to a motion sensor, which when triggered, is configured to cause the faucet to activate without physical contact with the faucet.

15. A mobile washing station, comprising:
a housing;
an articulating arm rotationally supported on the housing and configured to move relative to the housing between a retracted position and an extended position;
a basin supported on an end of the articulating arm, the basin including a faucet and a drain;
a clean water tank in fluid communication with the faucet via a water line;
a water pump configured to pump water from the clean water tank upward through the water line to the faucet; and
a wastewater tank in fluid communication with the basin via a drainage line.

16. The mobile washing station of claim 15, wherein the water line and the drainage line extend through an interior channel defined through the articulating arm to the faucet and the drain, respectively.

17. The mobile washing station of claim 15, wherein the housing is supported on a plurality of wheels.

18. The mobile washing station of claim 15, further comprising a UV lamp supported within the clean water tank, the UV lamp being configured to sanitize fluid stored within the clean water tank.

19. The mobile washing station of claim 15, further comprising a plurality of UV LEDs disposed along an interior surface of the water line, the plurality of UV LEDs being configured to sanitize fluid flowing through the water line.

20. The mobile washing station of claim 15, wherein the articulating arm includes:
a first arm rotationally supported on the housing; and
a second arm rotationally coupled to the first arm and supporting the basin such that when the articulating arm is in the retracted position the basin is overlapping the housing, and when the articulating arm is in the extended position the basin is positioned away from the housing.
